(19) United States
(12) Patent Application Publication
(10) Pub. No.: US 2007/0002694 A1
(43) Pub. Date: Jan. 4, 2007

(54) Guiding optical beam to optically writable surface

(76) Inventors: Lawrence N. Taugher, Loveland, CO (US); D. Mitchel Hanks, Fort Collins, CO (US); Paul W. Martin, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/174,221

(22) Filed: Jul. 2, 2005

(51) Int. Cl. G11B 11/00

(52) U.S. Cl. 369/13.01

(57) ABSTRACT

An optical mechanism includes an optical beam-generating mechanism and a light pipe. The optical-beam generating mechanism is to generate an optical beam. The light pipe is to guide the optical beam to an optically writable surface.

### BACKGROUND

Optical disc drives have historically been used to optically read data from and optically write data to data regions of optical discs. More recently, optical disc drives have been used to optically write images to label regions of optical discs. For example, in the patent application entitled “Integrated CD/DVD Recording and Label” [attorney docket 10011728-1], filed on Oct. 11, 2001, and assigned Ser. No. 09/976,877, a type of optical disc is disclosed in which a laser or other optical beam can be used to write to the label side of an optical disc.

A costly component of an optical disc drive is the optical pickup unit (OPU). The OPU is the optical mechanism by which an optical beam is generated, and then guided to the surface of an optical disc using a number of precisely arranged lenses and other components, including an objective lens, which have to be manufactured to high tolerances, and thus at high cost. Therefore, optical disc drives typically only have one OPU for cost and complexity reasons. An optical drive having just a single such optical mechanism for accessing both the label and the data sides of an optical disc, however, forces a user to remove the disc from the drive, flip it over, and reinsert the disc back into the drive when the optical drive needs to access the data side after having accessed the label side, and vice-versa.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated.

FIG. 1 is a diagram of an optical disc drive, according to an embodiment of the invention.

FIGS. 2, 3, and 4 are diagrams of optical mechanisms for the optical disc drive of FIG. 1, according to different embodiments of the invention.

FIG. 5 is a diagram depicting how a light pipe of the optical mechanisms of FIGS. 2, 3, and 4 can output an optical beam in the shape of an oval spot instead of a circular spot on an optical disc, according to an embodiment of the invention.

FIG. 6 is a diagram depicting how a light pipe of the optical mechanisms of FIGS. 2, 3, and 4 can output an optical beam with a smaller spot size on an optical disc, according to an embodiment of the invention.

FIG. 7 is a diagram of an optical beam-generating mechanism other than a diode, according to an embodiment of the invention.

FIG. 8 is a diagram depicting how several optical beam-generating sub-mechanisms can be used to generate an optical beam to be output onto the surface of an optical disc, according to an embodiment of the invention.

FIG. 9 is a diagram depicting how a heating element can be situated at the end of the light pipe for greater heating capability, according to an embodiment of the invention.

FIG. 10 is a diagram of an optical disc drive having two optical mechanisms for accessing both sides of an optical disc without having to have a user remove the disc from the drive, flip it over, and reinsert the disc into the drive, according to an embodiment of the invention.

FIG. 11 is a diagram of a light pipe of an optical mechanism of an optical disc drive that has a lower profile in height, but still transports the same volume of light, due to its being greater in width, according to an embodiment of the invention.

FIG. 12 is a diagram of an actuator arm that includes a light pipe and that may be used as part of an optical disc drive so that the optical disc drive has a lower profile in height, according to an embodiment of the invention.

FIG. 13 is a flowchart of a method of use for an optical disc drive having an optical mechanism with a light pipe, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

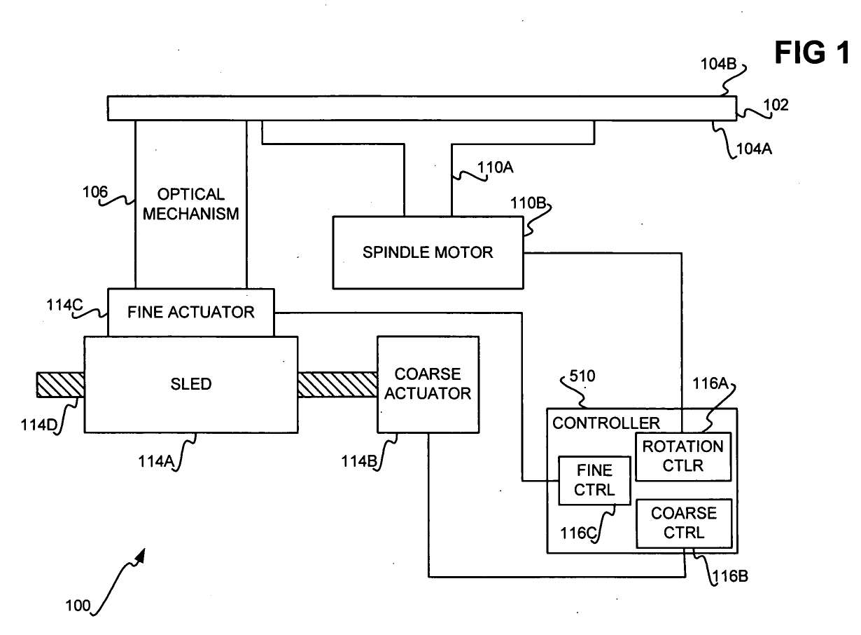

FIG. 1 shows an optical disc drive 100, according to an embodiment of the invention. The optical drive 100 is for reading from and/or writing to an optical disc 102 which has a label side 104A opposite a data side 104B. More specifically, the optical drive 100 is for reading from and/or writing to an optically writable label side 104A of the optical disc 102, and/or an optically writable label side 104B of the optical disc 102, which are collectively referred to as the sides 104 of the optical disc 102.

The optically writable data side 104B of the optical disc 102 includes a data region on which data may be optically written to and/or optically read by the optical drive 100. The data side 104B is thus the side of the optical disc 102 to which binary data readable by the optical drive 100 and understandable by a computing device is written, and can be written by the optical drive 100 itself. For instance, the data side 104B may be the data side of a compact disc (CD), a CD-readable (CD-R), which can be optically written to once, a CD-readable/writable (CD-RW), which can be optically written to multiple times, and so on. The data side 104B may further be the data side of a digital versatile disc (DVD), a DVD-readable (DVD-R), or a DVD that is readable and writable, such as a DVD-RW, a DVD-RAM, or a DVD+RW. The data side 104B may further be the data side of a high-capacity optical disc, such as a Blu-ray optical disc, and so on. Furthermore, there may be a data region on each side of the optical disc 102, such that the optical disc is double sided, and such that there is a label region on at least one of the sides of the disc.

The optically writable label side 104A of the optical disc 102 includes a label region on which an image may be optically written thereto, to effectively label the optical disc 102. The label side 104A is thus the side of the optical disc 102 to which visible markings can be optically written to realize a desired label image. For instance, the label side 104A may be part of an optical disc that is disclosed in the previously filed patent application assigned Ser. No. 09/976,877, which discloses an optically writable label side of an optical disc. It is noted in one embodiment that both the sides 104A and 104B of the optical disc 102 may have both label regions and data regions.

The optical drive 100 is depicted in FIG. 1 as including an optical mechanism 106. Different and specific embodiments of the optical mechanism 106 are described in detail later in the detailed description. In general, however, the optical mechanism 106 does not employ an objective lens, and further employs a light pipe to direct a generated optical beam to the surface of the optical disc 102. As such, the optical mechanism 106 is advantageous because it may not need costly, complex, and precisely arranged lenses and other components.

In particular, the optical mechanism 106 employing a light pipe, and not employing an objective lens, is applicable to using the optical mechanism 106 to optically write to the label side 104A of the optical disc 102, because less precision is needed to optically write to and/or read from the label side 104A, as opposed to optically writing to and/or reading from the data side 104B. In such an embodiment of the invention, the optical mechanism 106 may be referred to as an optical print head, because it is used to optically write marks to the label side 104A, to achieve a desired image on the label side 104A of the optical disc 102. However, in other embodiments, the optical mechanism 106 may also be able to be used to optically write to and/or read from the data side 104B, too.

The optical drive 100 is also depicted in FIG.1 as including a spindle 110A and a spindle motor 110B, which are collectively referred to as the first motor mechanism 110. The spindle motor 110B rotates the spindle 110A, such that the optical disc 102 correspondingly rotates. The first motor mechanism 110 may include other components besides those depicted in FIG. 1. For instance, the first motor mechanism 110 may include a rotary encoder or another type of encoder to provide for control of the spindle motor 110B and the spindle 110A.

The optical drive 100 is further depicted in FIG. 1 as including a sled 114A, a coarse actuator 114B, a fine actuator 114C, and a rail 114D, which are collectively referred to as the second motor mechanism 114. The second motor mechanism 114 moves the optical mechanism 106 to radial locations relative to a surface of the optical disc 102. The coarse actuator 114B is or includes a motor that causes the sled 114A, and hence the fine actuator 114C and the optical mechanism 106 situated on the sled 114A, to move radially relative to the optical disc 102 on the rail 114D. The coarse actuator 114B thus provides for coarse or large radial movements of the fine actuator 114C and the optical mechanism 106.

By comparison, the fine actuator 114C also is or includes a motor, and causes the optical mechanism 106 to move radially relative to the optical disc 102 on the sled 114A. The fine actuator 114C thus provides for fine or small movements of the optical mechanism 106. The second motor mechanism 114 may include other components besides those depicted in FIG. 1. For instance, the second motor mechanism 114 may include a linear encoder or another type of encoder to provide for control of the coarse actuator 114B and the sled 114A. Furthermore, either or both of the motor mechanisms 110 and 114 may be considered as the movement mechanism of the optical drive 100.

It is noted that the utilization of a fine actuator 114C and a coarse actuator 114B, as part of the second motor mechanism 114, is representative of one, but not all, embodiments of the invention. That is, to radially move the optical mechanism 106 in relation to the optical disc 102, the embodiment of FIG. 1 uses both a fine actuator 114C and a coarse actuator 114B. However, in other embodiments, other types of a second motor mechanism 114C can be used to radially move the optical mechanism 106 in relation to the optical disc 102, which do not require both a fine actuator 114C and a coarse actuator 114B. For instance, a single actuator or other type of motor may alternatively be used to radially move and position the optical mechanism 106 in relation to the optical disc 102. One such alternative embodiment is described later, at the end of the detailed description.

The optical drive 100 is additionally depicted in FIG. 1 as including a controller 116. The controller 116 can in one embodiment include at least a rotation controller 116A, a coarse controller 116B, and a fine controller 116C. The mechanisms 116 may each be implemented in software, hardware, or a combination of software and hardware. The rotation controller 116A controls movement of the spindle motor 110B, and thus controls rotation of the optical disc 102 on the spindle 110A, such as the angular velocity of the rotation of the optical disc 102. The coarse controller 116B controls the coarse actuator 114B, and thus movement of the sled 114A on the rail 114D. The fine controller 116C controls the fine actuator 114C, and thus movement of the beam source 106A on the sled 114A.

The controller 116 may further include other components besides those depicted in FIG. 1. For instance, the controller 116 can be responsible for turning on and off, and focusing, the optical beam 212, via control of the beam source 106A and the objective lens 106B. In addition, as can be appreciated by those of ordinary skill within the art, the components depicted in the optical drive 100 are representative of one embodiment of the invention, and do not limit all embodiments of the invention.

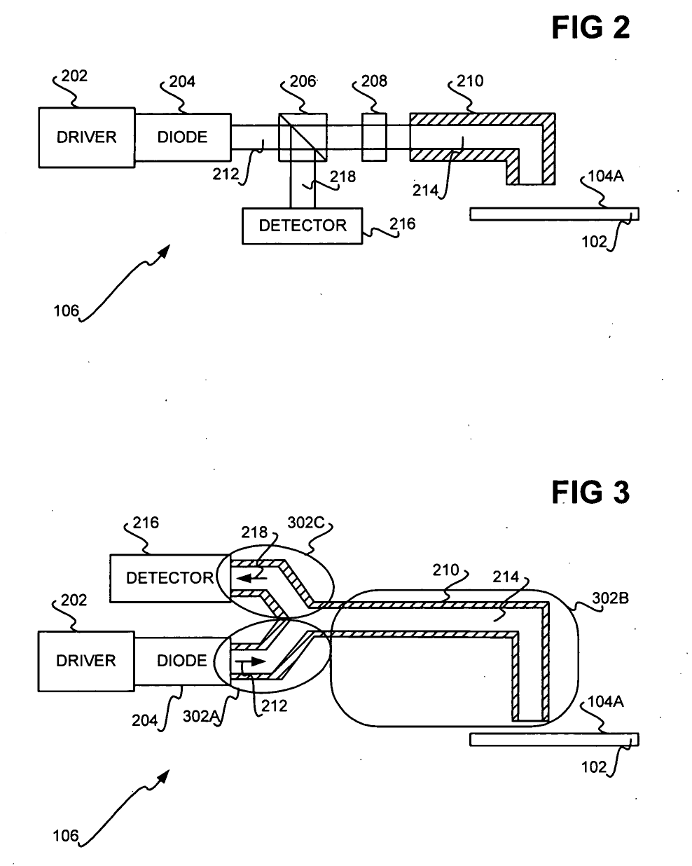

FIG. 2 shows the optical mechanism 106 of the optical disc drive 100 in detail, according to an embodiment of the invention. The optical mechanism 106 includes a driver 202, a diode 204, a polarizing beam splitter 206, a quarter wave plate 208, a light pipe 210, and a detector 216. The driver 202 controls the diode 204, and may be an integrated circuit (IC) driver, such as a metal-oxide semiconductor field-effect transistor (MOSFET) driver. The diode 204 is an optical beam diode, such as a laser diode, that generates an optical beam 212, such as a laser beam, as controlled by the driver 202. The diode 204 is more generally an optical beam-generating mechanism, or part of an optical beam-generating mechanism.

The optical beam 212 passes through a polarizing beam splitter 206 and a quarter wave plate 208, into a light pipe 210. The light pipe 210 guides or directs the optical beam 212 onto the optical disc 102, such as onto the label side 104A of the optical disc 102 as specifically depicted in FIG. 2. Thus, no objective lens is needed in the optical mechanism 106 to guide or direct the optical beam 212 onto the optical disc 102. The light pipe 210 has an inner passage 214 through which the optical beam 212 specifically travels when being guided by the light pipe 210. The inner passage 214 may have a circular cross-section in one embodiment of the invention. The light pipe 210 may be, for example, a fiber optic cable, a rigid light pipe, and/or a flexible light pipe. The optical beam 212 is for optically writing an image to the label side 104A of the optical disc 102, and/or for optically reading data from and/or optically writing data to the data side 104B of the optical disc 102.

The quarter wave plate 208 rotates the polarization of the optical beam 212 as it passes through the plate 208. The optical beam 212 passes through the polarizing beam splitter 206, and is not reflected by the beam splitter 206, because the beam splitter 206 is tuned so that it passes the optical beam 212. That is, the polarization of the optical beam 212 upon initial generation by the diode 204 is such that that the beam splitter 206 does not reflect the beam 212.

The optical beam 212 may be reflected off the optical disc 102 which is indicated in FIG. 2 as the reflected beam 218. This reflected beam 218 has its polarization rotated again as it passes back through the plate 208. As a result, the reflected beam 218 ultimately has a polarization that is different than the polarity of the initial beam 212 and to which the polarizing beam splitter 206 is tuned such that the beam splitter 206 does reflect the reflected beam 218. In particular, the reflected beam 218 is directed, or reflected, by the beam splitter 206 to the detector 216. The detector 216 may be a photodiode, or another type of photodetector, and measures or detects the strength of the reflected beam 134. The detector 216 is more generally a detection mechanism.

The optical mechanism 106 uses a polarizing beam splitter 206 and a quarter wave plate 208 to guide the reflected beam 218 back to the photodetector 216. However, in another embodiment, the polarizing beam splitter 206 and the quarter wave plate 208 may be omitted by appropriately designing the light pipe 210. FIG. 3 shows the optical mechanism 106 in detail, according to such an embodiment of the invention. Like-numbered components between FIG. 3 and FIG. 2 operate at least substantially the same between the optical mechanisms 106 of FIGS. 2 and 3, and the description of such components is not repeated in relation to FIG. 3 unless the manner by which they operate is different in relation to FIG. 3.

The light pipe 210 has segments 302A, 302B, and 302C, which are collectively referred to as the light pipe segments 302. The light pipe segment 302A is optically connected to the diode 204, and is optically connected to the light pipe segment 302B at an angle other than zero degrees, as is specifically depicted in FIG. 3. The optical beam 212, indicated as an arrow in FIG. 3, is output from the diode 212, into the light pipe segment 302A, and then into the light pipe segment 302B, towards the optical disc 102. The light pipe segment 302B is the segment from which the optical beam 212 is output towards a surface of the optical disc 102, such as the label side 104A as shown in FIG. 3.

The light pipe segment 302C is optically connected to the detector 216, and is optically connected to the light pipe segment 302B also at an angle other than zero degrees, as is specifically depicted in FIG. 3. The reflected optical beam 218, also indicated as an arrow in FIG. 3, thus travels from light pipe segment 302B into the light pipe segment 302C, and to the detector 216. A portion of the reflected optical beam 218, however, will be routed back to the diode 204 via the light pipe segment 302A. In one embodiment, approximately half of the reflected optical beam 218 is likely to be routed from the light pipe segment 302B to the light pipe segment 302C (and to the detector 216), and another half is likely to be routed from the light pipe segment 302B to the light pipe segment 302C (and to the diode 204).

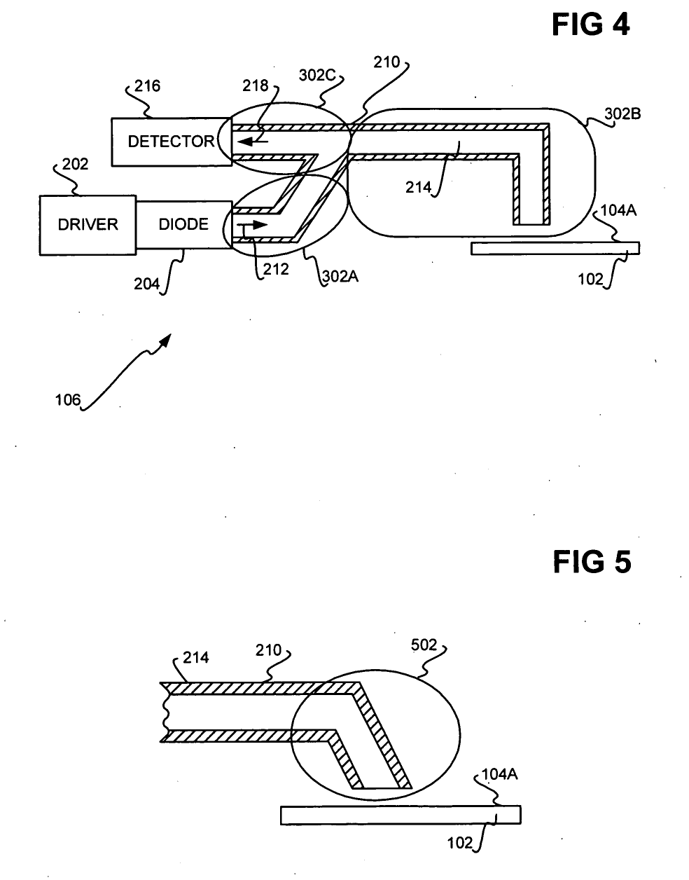

To lessen the portion of the reflected beam 218 that may be routed back to the diode 204, the light pipe 210 can be altered. FIG. 4 shows the optical mechanism 106 in detail, according to such an embodiment of the invention. Like-numbered components between FIG. 4 and FIGS. 2 and 3 operate at least substantially the same between the optical mechanisms 106 of FIGS. 2, 3, and 4, and the description of such components is not repeated in relation to FIG. 4 unless the manner by which they operate is different in relation to FIG. 4.

The light pipe 210 again has the light pipe segments 302, and the light pipe segment 302A remains optically connected to the diode 204, and optically connected to the light pipe segment 302B at an angle other than zero degrees. However, the light pipe segment 302C, while still being optically connected to the detector 216, is optically connected to the light pipe segment 302B in an in-line manner, at an angle at least substantially equal to zero degrees, if not zero degrees. The optical beam 212 generated by the driver 204 is routed from the light pipe segment 302A, to the segment 302B, and out to the surface of the optical disc 102, such as the label side 104A.

The reflected optical beam 218 is similarly routed back through the light pipe segment 302B and the light pipe segment 302C to the detector 216. Because the light pipe segment 302C is in-line with the light pipe segment 302B, and the light pipe segment 302A is not in-line with the light pipe segment 302B, most of the reflected optical beam 218 is routed from the segment 302B to the segment 302C. As a result, less of the reflected beam 218 is routed from the segment 302B to the segment 302A (and thus to the diode 204) in the embodiment of FIG. 4 than in the embodiment of FIG. 3.

The optical beam 212 in the embodiments of FIGS. 2, 3, and 4 is output onto the surface of the optical disc 102, such as the label side 104A, at a spot having a circular shape, or, in other words, in the shape of a circle. This is because the end of the light pipe 210 from which the optical beam 212 is output from the light pipe 210 onto the surface of the optical disc 102 is at substantially ninety degrees, if not at ninety degrees, to the surface of the optical disc 102. In other embodiments, the shape of the spot at which the optical beam 212 is output onto the surface of the optical disc 102 may be modified, by changing the light pipe 210. In these embodiments, the inner passage 214 of the light pipe 210 may be circular or non-circular.

FIG. 5 shows how the light pipe 210 may be changed so that the shape of the spot at which the optical beam 212 is output onto the surface of the optical disc 102 is an oval, according to an embodiment of the invention. The end of the light pipe 210 that is incident to the surface of the optical disc 102 is particularly identified in FIG. 5 as the end 502. In the embodiment of FIG. 5, the end 502 of the light pipe 210 from which the optical beam 212 is output onto the surface of the optical disc 102, such as the label side 104A, is at an angle other than ninety degrees to the surface of the optical disc 102. Therefore, in this embodiment, the optical beam 212 is output from the end 502 of the light pipe 210 at a spot having an oval shape, or in other words, in the shape of an oval, on the surface of the optical disc 102, even though the inner passage 214 is circular in shape. An oval shape may be desirable to increase the heating time of the surface of the optical disc 102 due to the optical beam 212, since the oval shape has a larger surface area on the surface of the optical disc 102 as compared to a circular shape.

Thus, the optical beam 212 in the embodiments of FIGS. 2, 3, and 4 is output onto the surface of the optical disc 102, such as the label side 104A, at a spot that may have a circular or an oval shape. In some situations, it may be desired to reduce the size, or the surface area, of this spot, for better precision and to achieve higher pixel density on the surface of the optical disc 102. Reducing the size of the spot at which the optical beam 212 is output from the light pipe 210 may be modified by changing the light pipe 210.

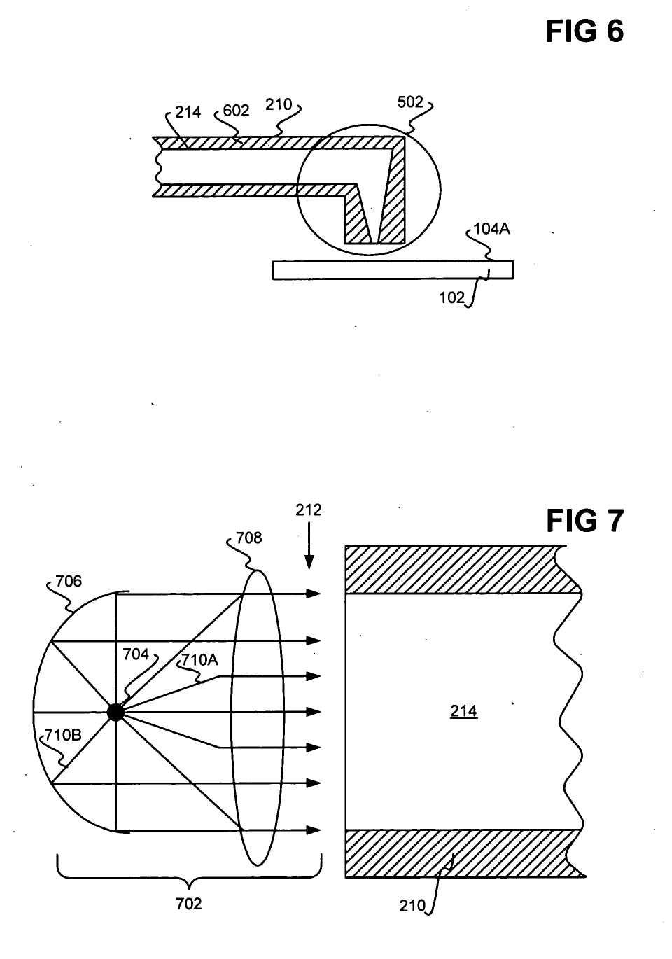

FIG. 6 shows how the light pipe 210 may be changed so that the size of the spot at which the optical beam 212 is output onto the surface of the optical disc 102 is reduced, according to an embodiment of the invention. The end 502 that is incident to the surface of the optical disc 102, such as the label side 104A, is again particularly identified in FIG. 6. In the embodiment of FIG. 6, the passage 214 at the end 502 is tapered so that the optical beam 212 is output from the end 502 onto the surface of the optical disc 102 at a smaller spot size than if the passage 214 were not tapered. The outside part 602 of the light pipe 210 is not specifically shown as being tapered in FIG. 6, and only the inside passage 214 is shown as being tapered. However, in another embodiment, both the inside passage 214 and the outside part 602 may be tapered. As used herein, the phrase “the light pipe 210 being tapered” is intended to encompass both just the inside passage 214 of the light pipe 210 being tapered, as well as the inside passage 214 and the outside part 602 of the light pipe 210 being tapered.

The optical mechanism 106 of FIGS. 2, 3, and 4 has been described as having an optical beam-generating mechanism that is specifically, or that specifically includes, an optical beam diode 204, such as a laser diode, which emits an optical beam 212 that can be a laser beam, for instance. In other embodiments, the optical-beam generating mechanism may be or include components other than an optical beam diode like a laser diode. FIG. 7 shows an optical beam-generating mechanism 702, according to such an embodiment of the invention.

The optical beam-generating mechanism 702 includes a light source 704, a concave reflecting surface 706, such as a mirror, and a collimating lens 708. The light source 704 outputs light beams in all directions, such as the light beams 710A and 710B. Those that are directed towards the collimating lens 708, such as the light beam 710A, are aligned by the lens 708 to point in the same direction. Furthermore, the light beams that are directed towards the concave reflecting surface 706, such as the light beam 710B, are aligned by the concave reflecting surface 706 to point in this same direction, and be directed towards the collimating lens 708. As a result, the light beams output through the collimating lens 708 are all aligned in the same direction, resulting in the generation of the optical beam 212, which then enters the passage 214 of the light pipe 210 as has been described.

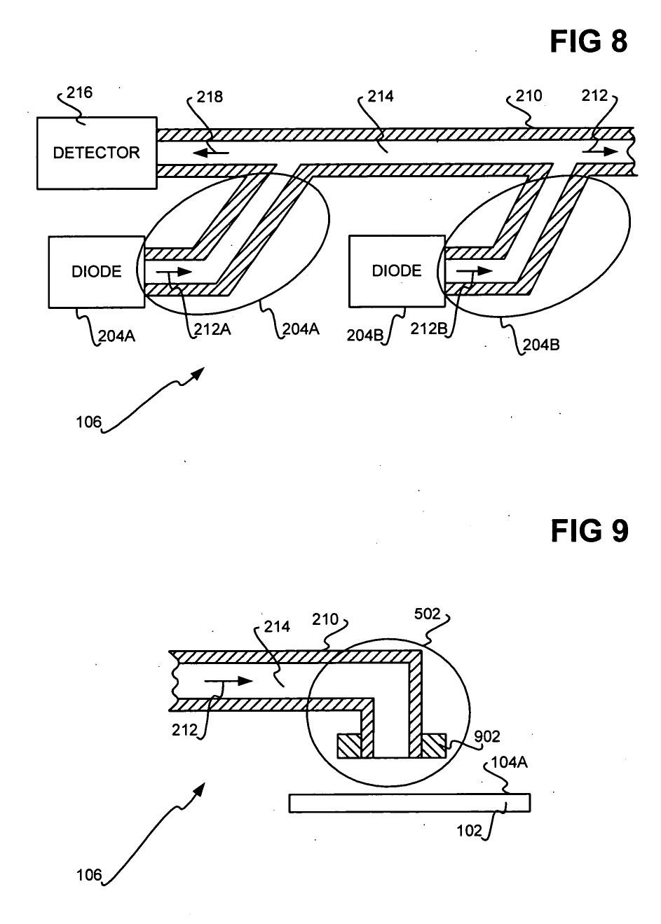

The optical mechanism 106 of FIGS. 2, 3, and 4 has alternatively been described as having a single optical beam diode 204, such that the optical beam-generating mechanism is made up of this one diode 204. In other embodiments, however, the optical beam-generating mechanism may include a number of optical beam-generating sub-mechanisms, such as a number of optical beam diodes, that each output a portion of the ultimate optical beam 212 that is output onto the surface of the optical disc 102. FIG. 8 shows a portion of the optical mechanism 106, according to such an embodiment of the invention. It is noted that while the reflected optical beam 218 and the detector 216 are depicted in FIG. 8, they operate substantially the same as has been described in relation to FIG. 4, for instance, and such description is not provided in relation to FIG. 8 to avoid descriptive redundancy.

The optical mechanism 106 of FIG. 8 includes optical beam diodes 204A and 204B, collectively referred to as the optical beam diodes 204. The optical beam diodes 204 may each be considered an optical beam-generating sub-mechanism that is part of an optical beam-generating mechanism. As specifically depicted in FIG. 8, the light pipe 210 can be considered as having light pipe segments 212A and 212B, collectively referred to as the light pipe segments 212, which correspond and are optically connected to the optical beam diodes 204. The diode 204A outputs a portion 212A of the optical beam 212, whereas the diode 204B outputs a portion 212B of the optical beam 212. The portion 212A is input into the light pipe segment 702A, whereas the portion 212B is input into the light pipe segment 702B. The light pipe 210 thus combines to the portions 212A and 212B to generate the optical beam 212.

The diodes 204 may generate their respective portions of the optical beam 212 at the same or different wavelengths. The diodes 204 may generate the same wavelength of light, for instance, so that the resulting optical beam 212 has a higher power and is output onto the surface of the optical disc 102 with a greater intensity. The diodes 204 may generate different wavelengths of light, as another example, so that the resulting optical beam 212 is multi-colored when output onto the surface of the optical disc 102. Furthermore, while just two diodes 204, or two optical beam-generating sub-mechanisms, are depicted in FIG. 8, in other embodiments there may be more than two such diodes or optical beam-generating sub-mechanisms.

One manner by which the surface of the optical disc 102, such as the label side 104A, can be heated to a greater temperature, can be heated such that a given region of the surface is exposed to a greater temperature over a longer period of time, and/or can be heated to a given temperature more quickly, is by changing the shape of the spot at which the optical beam 212 is output onto the surface of the optical disc 102 from a circle to an oval, as has been described. FIG. 9 shows another way by which the surface of the optical disc 102 can be heated to a greater temperature, can be heated such that a given region of the surface is exposed to a greater temperature over a longer period of time, and/or can be heated to a given temperature more quickly, according to an embodiment of the invention. A portion of the optical mechanism 106 is depicted in FIG. 9 in which a heating element 902 is disposed or situated at the end 502 of the light pipe 210.

Thus, the surface of the optical disc 102 to which the end 502 of the light pipe 210 is incident is heated by the heating element 902, in addition to by the optical beam 214 traveling through the passage 214 of the light pipe 210 and that is output onto the surface of the optical disc 102. The embodiment of FIG. 9 can be combined with other embodiments of the invention that have been depicted and described. For instance, the embodiment of FIG. 9 can be combined with the embodiment of FIG. 5, so that the optical beam 214 is output from the light pipe 210 at an oval spot on the surface of the optical disc 102, which in combination with the heating element 902 provides for even greater heating capability. The heating element 902 may be a resistive heater, a heating lamp, or another type of heating element.

The optical mechanism 106 of various embodiments of the invention that have been described is at least for optically writing to the label side 104A of the optical disc 102. In one embodiment, the optical mechanism 106 may be able to be also employed to optically write to and/or optically read from the data side 104B of the optical disc 102. In such an embodiment, the optical disc 102 would have to be removed from the optical disc drive 100, flipped or turned over, and reinserted into the optical disc drive 100 for the optical mechanism 106 to access the label side 104A after the data side 104B of the optical disc 102 has been accessed, and vice-versa. This can be inconvenient for the user, however. In such situations, and in the embodiment where the optical mechanism 106 cannot be employed to optically write to and/or optically read from the data side 104B of the optical disc 102, the optical disc drive 100 may be modified to include two optical mechanisms, including the optical mechanism 106.

FIG. 10 shows the optical disc drive 100, according to such an embodiment of the invention. In particular, the optical disc drive 100 includes the optical mechanism 106 that has been described, as well as another optical mechanism 1002 situated or disposed opposite to the optical mechanism 106. The other components of the optical disc drive 100 that are depicted in FIG. 1, such as various motor mechanisms and controllers, are not shown in FIG. 10 for illustrative convenience. Furthermore, the optical disc drive 100 of FIG. 10 may have additional components besides those depicted in FIG. 10, such as one or more motor mechanisms for the optical mechanism 1002. The optical mechanism 106 is incident to the label side 104A of the optical disc 102 that has been inserted into the optical disc drive 100, whereas the optical mechanism 1002 is incident to the data side 104B of the optical disc 102 that has been inserted into the optical disc drive 100.

As a result, access to both the label side 104A and the data side 104B of the optical disc 102 can be achieved by the optical disc drive 100, without having to have the user remove the disc 102 from the drive 100, flip it over, and reinsert the disc 102 into the drive 100 for the drive 100 to access the label side 104A after having accessed the data side 104B, and vice-versa. The optical mechanism 106 can be in accordance with the embodiments of the invention that have been described, such that it does not employ an objective lens. By comparison, the optical mechanism 1002 in one embodiment can be a conventional optical pickup unit (OPU), and thus employ an objective lens as well as other costly and complex components. In another embodiment, however, the optical mechanism 1002 may be another instance of the optical mechanism 106 that has been described.

The optical disc drive 100 that has been described can further have an internal form factor, suitable for insertion into a computing device like a desktop computer or a laptop computer, or an external form factor, in which it is housed in an enclosure and connected by an external cable to a computing device. Especially in the former situation, having two optical mechanisms within the optical disc drive 100, as in FIG. 10, may be difficult to accomplish to yield the desired form factor. For example, the light pipe 210 of the optical mechanism 106 may require an internal passage 214 that provides for a given volume of light to be transported. Where a light pipe 210 with an internal passage 214 having a circular cross section cannot achieve such a given volume of light and still be compact enough in height so that the optical disc drive 100 achieves a desired form factor, the light pipe 210 may be modified in shape.

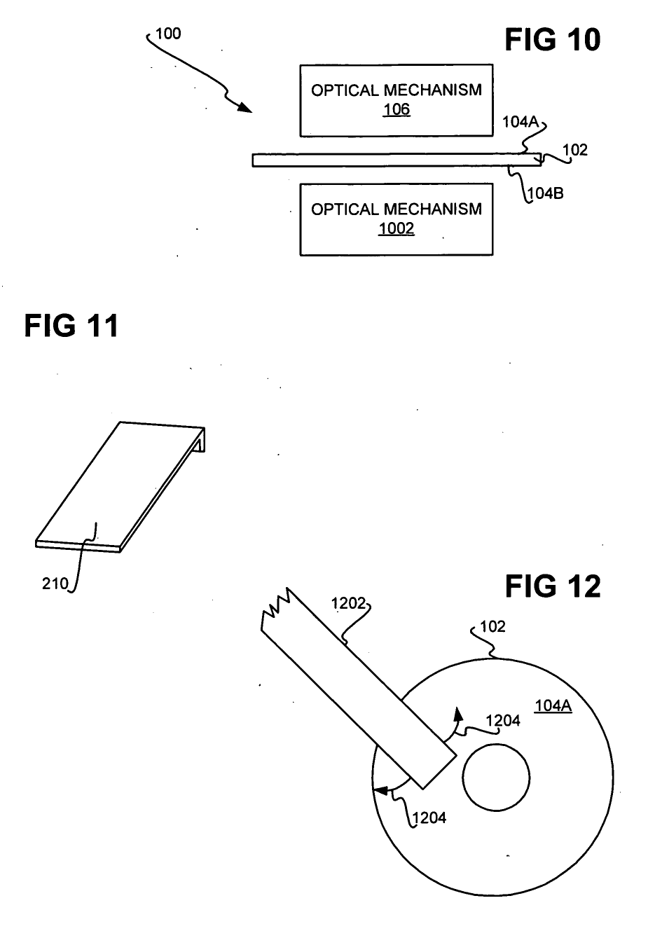

FIG. 11 shows an example of the light pipe 110 that has such a modified shape so that the light pipe 210 is sufficiently compact in height so that the optical disc drive 100 achieves a desired form factor, according to an embodiment of the invention. In particular, the light pipe 110 has a rectangular shape, and is wider, but shorter in height, than the other embodiments of the light pipe 110 that have been described and depicted. The extra width of the light pipe 110 allows for the same volume of light to be transported by the light pipe 110, even where the light pipe 110 is shorter in height.

Another way to ensure that the optical disc drive 100 can achieve a desired form factor even when it includes two optical mechanisms is to employ an actuator arm that can be or include the light pipe 210, instead of, for instance, using the fine actuator 114C and the coarse actuator 114B of FIG. 1 that have been described. FIG. 12 shows a top view of an example of such an actuator arm 1202 in relation to the label side 104A of the optical disc 102, according to an embodiment of the invention. The actuator arm 1202 may be part of the movement mechanism of the optical disc drive 100 that has been described in relation to FIG. 1.

The actuator arm 1202 may be or include the light pipe 210. Where the light pipe 210 is flexible, the actuator arm 1202 may include a rigid element, such that the light pipe 210 is not the only part of the actuator arm 1202. Where the light pipe 210 is rigid, the light pipe 210 may be the only part of the actuator arm 1202. To radially move the actuator arm 1202, and hence the light pipe 210 and the optical mechanism 106, in relation to the label side 104A or another surface of the optical disc 102 (as well as vice-versa), the actuator arm 1202 is rotated back or forth, as indicated by the arrows 1204 in FIG. 12.

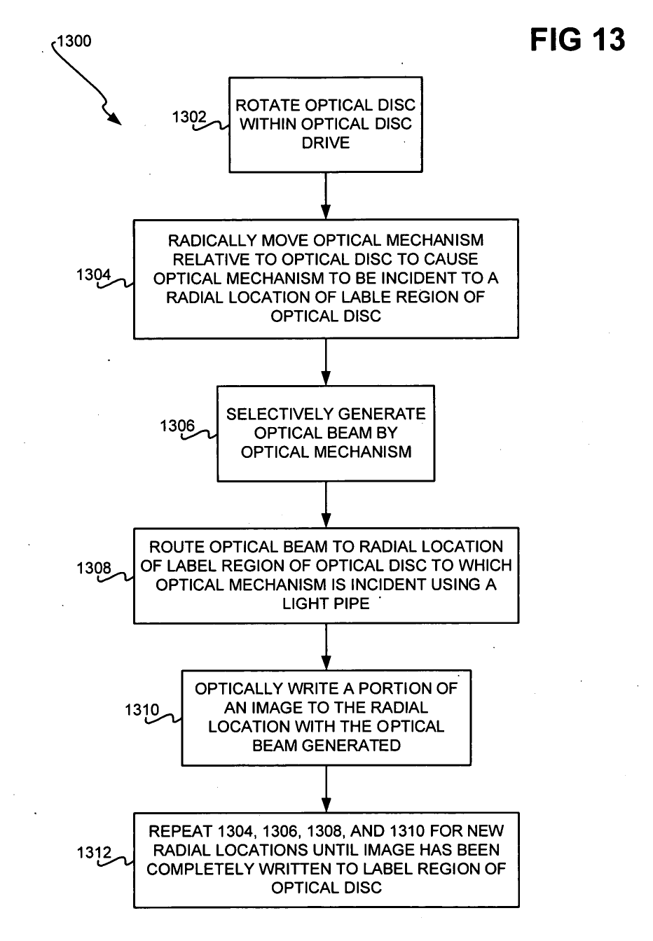

FIG. 13 shows a method 1300 for optically writing an image to the optically writable label side 104A of the optical disc 102 with the optical drive 100 having the optical mechanism 106 with the light pipe 210 that has been described, according to an embodiment of the invention. The method 1300 may thus be performed by the components of the optical drive 100 that have been described. At least some components of the method 1300 may be implemented as computer program parts of a computer program stored on a computer-readable medium. The medium may be a magnetic storage medium, such as a hard disk drive, an optical storage medium, such as an optical disc, and/or a semiconductor storage medium, such as a memory, among other types of computer-readable media.

The optical disc 102 is initially rotated within the optical drive 100 (1302). The optical mechanism 106 is radially moved relative to the optical disc 102 to cause the optical mechanism 106 to be incident to a given radial location of a label region of the optical disc 102 (1304). For instance, where the optical mechanism 106 includes the actuator arm 1202, the actuator arm 1202 that has been described can be rotated. The label region of the optical disc 102 can in one embodiment be the label side 104A of the optical disc 102. The optical beam 212 is then selectively generated by the optical mechanism 106 (1306).

The optical beam 212 is routed to the radial location of the label region of the optical disc 102 to which the optical mechanism 106 is incident using the light pipe 210, as has been described (1308). Routing of the optical beam 212 that is selectively generated and routed to the radial location of the label region of the optical disc 102, as the optical disc 102 is being rotated, therefore enables the optical beam 212 to optically write to this radial location a portion of an image to be optically written to the label region (1310). Parts 1304,1306,1308, and 1310 of the method 1300 are repeated for new radial locations of the label region of the optical disc 102, until the desired image has been completely written to the label region of the optical disc 102.

It is noted that, although specific embodiments have been illustrated and described herein, it will be appreciated by those of ordinary skill in the art that any arrangement calculated to achieve the same purpose may be substituted for the specific embodiments shown. For instance, embodiments of the invention have been substantially described in which a light pipe is employed to guide an optical beam to the optically writable label side of an optical disc. In an alternative embodiment, however, a light pipe may be used to guide the optical beam to any type of optically writable surface that is heat and/or light sensitive, and not just to the optically writable label side of an optical disc. This application is thus intended to cover any adaptations or variations of the disclosed embodiments of the present invention. Therefore, it is manifestly intended that this invention be limited only by the claims and equivalents thereof.

We claim:

1. An optical mechanism comprising:
an optical beam-generating mechanism to generate an optical beam; and,
a light pipe to guide the optical beam to an optically writable surface.

2. The optical mechanism of claim 1, wherein the optically writable surface is part of an optical disc, the optical mechanism being for an optical disc drive into which the optical disc is inserted.

3. The optical mechanism of claim 1, wherein the light pipe is to guide the optical beam to the surface without employing an objective lens.

4. The optical mechanism of claim 1, further comprising a detection mechanism to detect the optical beam as reflected off the surface.

5. The optical mechanism of claim 4, further comprising:
a polarizing beam splitter optically situated between the optical beam-generating mechanism and the light pipe; and,
a quarter wave plate optically situated between the polarizing beam splitter and the light pipe,
wherein the polarizing beam splitter guides the optical beam as reflected off the surface and as polarized by the quarter wave plate to the detection mechanism.

6. The optical mechanism of claim 4, wherein the light pipe comprises:
a first light pipe segment optically connected to the optical beam-generating mechanism;
a second light pipe segment from which the optical beam is output towards the surface; and,
a third light pipe segment optically connected to the detection mechanism.

7. The optical mechanism of claim 6, wherein the first light pipe segment and the third light pipe segment each are optically connected to the second light pipe segment at an angle other than zero degrees.

8. The optical mechanism of claim 6, wherein the first light pipe segment is optically connected to the second light pipe segment at an angle other than zero degrees, and the third light pipe segment is optically connected in-line to the second light pipe segment at an angle at least substantially equal to zero degrees.

9. The optical mechanism of claim 1, wherein an end of the light pipe is incident to the surface at an angle substantially equal to ninety degrees, such that the optical beam is output onto the surface by the light pipe in the form of a substantially circular spot.

10. The optical mechanism of claim 1, wherein an end of the light pipe is incident to the surface at an angle other than ninety degrees, such that the optical beam is output onto the surface by the light pipe in the form an oval spot.

11. The optical mechanism of claim 1, wherein the light pipe is tapered at an end thereof that is incident to the surface.

12. The optical mechanism of claim 1, wherein the optical beam-generating mechanism comprises a plurality of optical-beam generating sub-mechanisms, each of which is to generate a portion of the optical beam, such that the light pipe is to combine all the portions of the optical beam into the optical beam.

13. The optical mechanism of claim 12, wherein the light pipe comprises a plurality of light pipe segments, each light pipe segment optically connected to a corresponding one of the optical-beam generating sub-mechanisms.

14. The optical mechanism of claim 12, wherein the portion of the optical beam generated by each optical-beam generating sub-mechanism has a same wavelength as other of the optical-beam generating sub-mechanisms.

15. The optical mechanism of claim 12, wherein the portion of the optical beam generated by each optical-beam generating sub-mechanism has a different wavelength as compared to other of the optical-beam generating sub-mechanisms.

16. The optical mechanism of claim 1, wherein the optical beam-generating mechanism comprises:
a light source to generate light; and,
a concave reflecting mechanism to generate the optical beam from the light.

17. The optical mechanism of claim 1, further comprising a heating element situated at an end of the light pipe from which the optical beam is output towards the surface, the heating element heating the surface where the optical beam is output incident thereto.

18. An optical mechanism comprising:
means for generating an optical beam; and,
means for optically guiding the optical beam to an optically writable surface.

19. The optical mechanism of claim 18, further comprising means for detecting the optical beam as reflected off the surface.

20. An optical disc drive comprising:
an optical mechanism to generate an optical beam and, using a light pipe, to guide the optical beam to a surface of an optical disc inserted into the optical disc drive; and,
a movement mechanism to move the optical mechanism radially relative to a hub of the optical disc.

21. The optical disc drive of claim 20, wherein the movement mechanism comprises an actuator arm of which the light pipe is a part, such that the actuator arm is rotated to cause the optical mechanism to move radially relative to the optical disc inserted into the optical disc drive.

22. The optical disc drive of claim 20, wherein the optical mechanism is a first optical mechanism capable of optically writing an image to a label side of the optical disc, the optical disc drive further comprising a second optical mechanism capable of optically writing to and/or optically reading from a data side of the optical disc.

23. The optical disc drive of claim 22, wherein the first optical mechanism is capable of optically writing the image to the label side of the optical disc without employing an objective lens, and wherein the second optical mechanism employs an objective lens in optically writing to and/or optically reading from the data side of the optical disc.

24. The optical disc drive of claim 22, wherein the first optical mechanism is situated opposite the second optical mechanism, with the optical disc inserted into the optical disc drive between the first and the second optical mechanisms, such that the first optical mechanism is capable of optically writing the image to the label side of the optical disc, without the optical disc being removed, flipped over, and reinserted into the optical disc drive.

25. The optical disc drive of claim 20, wherein the optical mechanism comprises:
an optical beam-generating mechanism to generate the optical beam; and,
a detection mechanism to detect the optical beam as reflected off the surface of the optical disc.

26. The optical disc drive of claim 25, wherein the light pipe comprises:
a first light pipe segment optically connected to the optical beam-generating mechanism;
a second light pipe segment from which the optical beam is output to the surface of the optical disc; and,
a third light pipe segment optically connected to the detection mechanism.

27. The optical disc drive of claim 25, wherein the optical beam-generating mechanism comprises a plurality of optical-beam generating sub-mechanisms, each of which is to generate a portion of the optical beam, such that the light pipe is to combine all the portions of the optical beam into the optical beam and guide the optical beam to the surface of the optical disc.

28. A method comprising:
rotating an optical disc;
selectively generating an optical beam by an optical mechanism;
routing the optical beam to a radial location of a label region of an optical disc to which the optical mechanism is incident via a light pipe of the optical mechanism; and,
optically writing a portion of an image to the radial location with the optical beam as the optical disc is rotated.

29. The method of claim 28, further comprising:
radially moving the optical mechanism relative to the optical disc to cause the optical mechanism to be incident to a new radial location of the label region of the optical disc; and,
repeating generating the optical beam, routing the optical beam, and optically writing a portion of the image, for the new radial location.

30. The method of claim 29, wherein radially moving the optical mechanism relative to the optical disc comprises rotating an actuator arm of which the light pipe is a part.
